(19) United States
(12) Patent Application Publication
(10) Pub. No.: US 2026/0141217 A1
(43) Pub. Date: May 21, 2026

(54) PARALLEL CAUSAL LINEAR ATTENTION

(71) Applicant: ADOBE INC., SAN JOSE, CA (US)

(72) Inventors: Nikolaos Vlassis, San Jose, CA (US); Haoliang Wang, Sunnyvale, CA (US)

(21) Appl. No.: 18/953,757

(22) Filed: Nov. 20, 2024

(51) Int. Cl. G06N 3/0455; G06F 12/02

(52) U.S. Cl. CPC G06N 3/0455; G06F 12/023

(57) ABSTRACT

A method, apparatus, non-transitory computer readable medium, and system for performing parallel causal linear attention include obtaining a query data block, a key data block, and a value data block of a neural network model. Using at least one processor, embodiments generate a first intermediate data block based on the key data block and the value data block. Embodiments then generate a second intermediate data block that accumulates values of the first intermediate data block and previous first intermediate data blocks according to a data block ordering. Embodiments generate a linear attention data block based on the second intermediate data block, the query data block, the key data block, and the value data block. Embodiments then perform a linear attention mechanism based on the linear attention data block.

### BACKGROUND

The following relates generally to data processing, and more specifically to performing attention operations. Data processing involves manipulating different types of data to achieve desired results, such as extract additional information and insights. Various forms of data processing include image processing, audio processing, sequence prediction, and text processing. Image processing, for example, may involve enhancing the visual quality of an image or extracting specific information from it. Audio processing may include operations to refine sound quality or identify certain audio patterns. Sequence prediction may focus on forecasting future data points based on historical patterns, and text processing may involve parsing and transforming textual data for use in language applications. These data processing techniques apply a series of steps to import, analyze, and transform the data, producing refined outputs for specific tasks.

Recently, machine learning (ML) techniques have been developed and applied to data processing tasks. For example, ML techniques are currently the state of the art for data generation tasks such as image and text generation. Attention operations are an ML technique that enables models to identify and focus on relevant parts of the input data, and are heavily used in artificial intelligence (AI) and data generation applications. Attention operations can be applied across various data types, helping to improve the performance of ML models in tasks like language translation, image analysis, and sequence prediction.

### SUMMARY

Embodiments of the inventive concepts described herein include systems and methods for performing causal linear attention in O(n) time complexity. In this context, O(n) indicates that the time required to complete the attention operation scales approximately linearly with the length of the input sequence. As the sequence length increases, the computation time grows proportionally, rather than quadratically as in conventional attention mechanisms. Embodiments include a linear attention apparatus that is configured to partition query, key, and value vectors into query, key, and value blocks. The blocks are partitioned such that each block represents a fixed-size segment (e.g., d×d, where d is the dimension of the embedding space or hidden representation size, which is typically much smaller than the sequence length) of the input sequence with length n. Embodiments then perform parallel processing of key-value interactions across all blocks simultaneously, followed by accumulating cross-block interactions through cumulative sums, and finally applying query operations to generate output vectors. By partitioning and processing an input sequence in this way, embodiments can perform attention operations on data in approximately O(n) time.

A method, apparatus, non-transitory computer readable medium, and system for performing attention operations are described. One or more aspects of the method, apparatus, non-transitory computer readable medium, and system include obtaining a query data block, a key data block, and a value data block of a neural network model; generating, using at least one of the plurality of processors, a first intermediate data block based on the key data block and the value data block; generating, using at least one of the plurality of processors, a second intermediate data block that accumulates values of the first intermediate data block and one or more previous first intermediate data blocks according to a data block ordering; generating, using at least one of the plurality of processors, a linear attention data block based on the second intermediate data block, the query data block, the key data block, and the value data block; and performing a linear attention mechanism of the neural network model based on the linear attention data block.

A method, apparatus, non-transitory computer readable medium, and system for performing attention operations are described. One or more aspects of the method, apparatus, non-transitory computer readable medium, and system include obtaining a query data block, a key data block, and a value data block of a neural network model; generating a first intermediate data block based on the key data block and the value data block; generating a second intermediate data block that accumulates values of the first intermediate data block and one or more previous first intermediate data blocks; generating a linear attention data block based on the second intermediate data block, the query data block, the key data block, and the value data block; and performing a linear attention mechanism of the neural network model based on the linear attention data block.

An apparatus, system, and method for performing attention operations are described. One or more aspects of the apparatus, system, and method include a plurality of processors; at least one memory storing code executable by the plurality of processors; and a neural network model configured to generate a first intermediate data block based on a key data block and a value data block, generate a second intermediate data block that accumulates values of the first intermediate data block and one or more previous first intermediate data blocks, generate a linear attention data block based on the second intermediate data block, a query data block, the key data block, and the value data block, and perform a linear attention mechanism based on the linear attention data block.

### BRIEF DESCRIPTION OF THE DRAWINGS

FIG. 1 shows an example of a linear attention system according to aspects of the present disclosure.

FIG. 2 shows an example of a linear attention apparatus according to aspects of the present disclosure.

FIG. 3 shows an example of a conventional attention operation according to aspects of the present disclosure.

FIG. 4 shows an example of block allocation according to aspects of the present disclosure.

FIG. 5 shows an example of a guided latent diffusion model according to aspects of the present disclosure.

FIG. 6 shows an example of a U-Net according to aspects of the present disclosure.

FIG. 7 shows an example of a method for performing parallel causal linear attention in three passes according to aspects of the present disclosure.

FIG. 8 shows an example of a method for performing a linear attention operation in parallel according to aspects of the present disclosure.

FIG. 9 shows an example of a machine learning algorithm according to aspects of the present disclosure.

FIG. 10 shows an example of a computing device according to aspects of the present disclosure.

### DETAILED DESCRIPTION

Recently, users have incorporated generative machine learning (ML) models into their creative process, as these models have the capability to automatically generate novel content such as images, music, and text. Generative ML models function by learning from vast amounts of data to capture underlying patterns and distributions, enabling them to produce new examples that are indistinguishable from authentic data. Among the various classes of generative models, Generative Adversarial Networks (GANs) and Variational Autoencoders (VAEs) are particularly popular. GANs operate through a competitive process between two neural networks-a generator that creates images and a discriminator that evaluates them-enhancing the quality of generation over time. VAEs, on the other hand, optimize a probabilistic framework to encode and decode images.

More recently, attention has shifted towards Denoising Diffusion Probabilistic Models (DDPMs), a class of generative models that offer significant advancements in image quality and variability. DDPMs work by initially introducing noise to an image and then learning to reverse this process, effectively ‘denoising’ to generate new images. This process involves a gradual transformation from a random noise distribution back to the data distribution, guided by a learned diffusion process.

DDPMs incorporate attention mechanisms to enable the model to consider spatial relationships across the entire image during the denoising process. At each denoising step, the model computes attention scores between each pixel and all other pixels in the image, which allows the model to reference distant image regions when determining how to denoise a particular area. Their conventional attention computation scales quadratically with image size, as each pixel must consider every other pixel, which can create performance bottlenecks for high-resolution images.

Large Language Models (LLMs) also rely on attention mechanisms to process and generate text. When generating text, these models use attention to reference previously generated words to determine the next word in the sequence. This attention operation involves computing relationships between the current position and all previous positions in the sequence. As with DDPMs, the computational cost of attention in LLMs increases quadratically with the length of the text sequence, limiting the practical length of text these models can process.

Embodiments of the present disclosure improve the efficiency of attention operations in machine learning models. In contrast with conventional models, embodiments perform attention operations that scale approximately linearly with the length of the input data. In DDPMs, the input data corresponds to a two-dimensional array of pixel values, where each pixel is represented by a vector of dimension d encoding features such as color channels and other spatial information. In LLMs, the input data may include a sequence of token embeddings, where each token (e.g., a word or subword unit) is represented by a vector of dimension d encoding semantic and syntactic features. Embodiments include a linear attention apparatus configured to partition these input vectors into blocks of size d×d, where each block represents a fixed segment of the input sequence length n. The apparatus processes key-value interactions for all blocks in parallel, rather than sequentially, and then accumulates cross-block interactions through cumulative sums before applying query operations to generate output vectors. The output vectors are refined versions of the input vectors, where each output has been adjusted based on relevant context from earlier positions in the sequence, allowing the model to capture long-range patterns in the data. According to some aspects, embodiments achieve significant speed increases over conventional attention approaches, particularly for inference tasks with batch size of one and single-head attention architectures. Notably, embodiments can perform attention operations during inference with O(n) complexity.

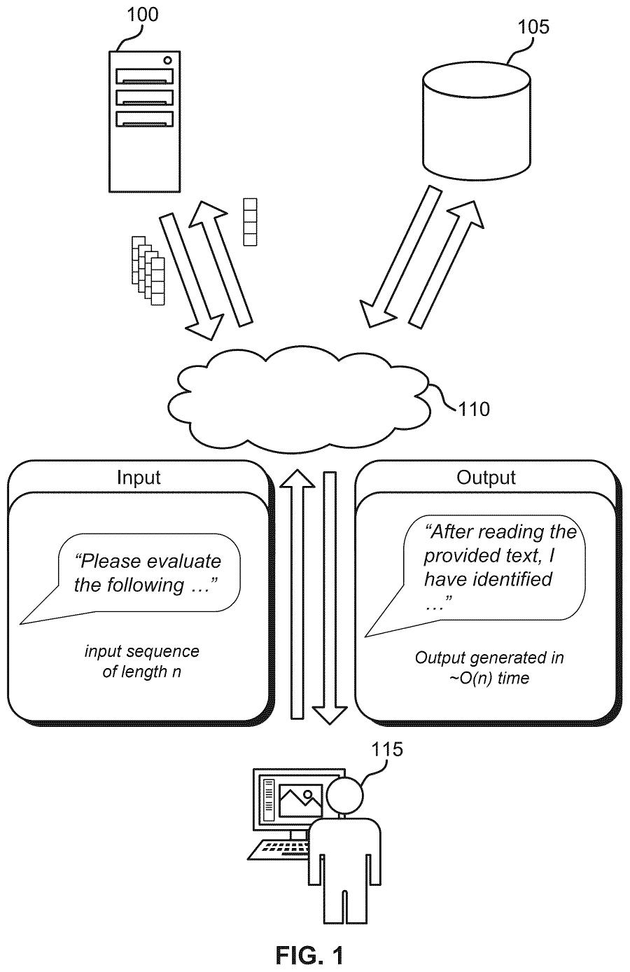

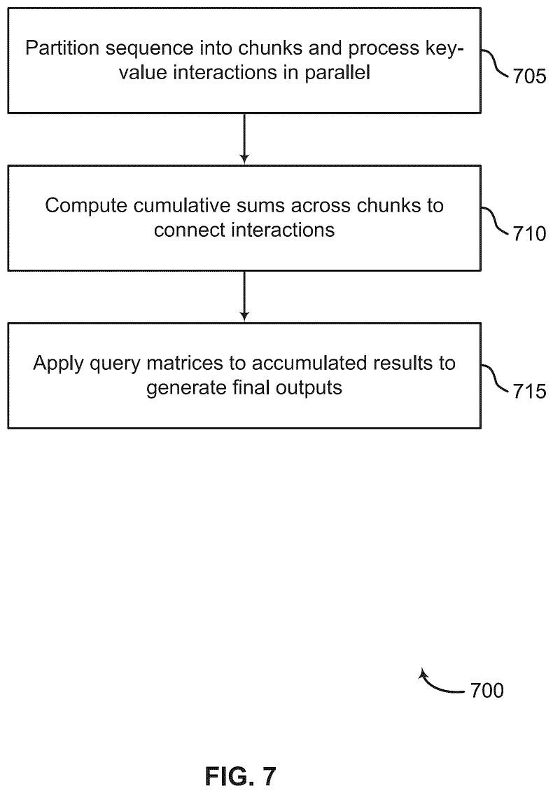

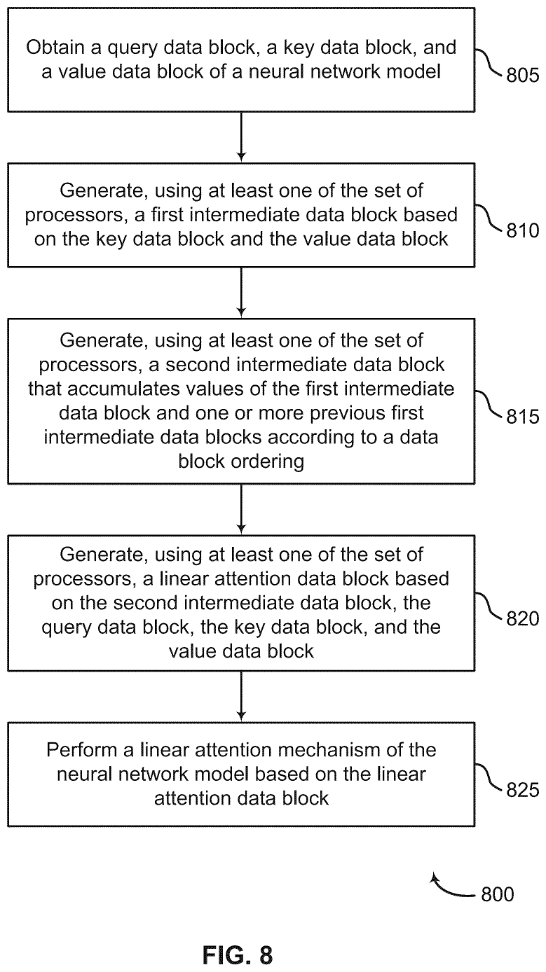

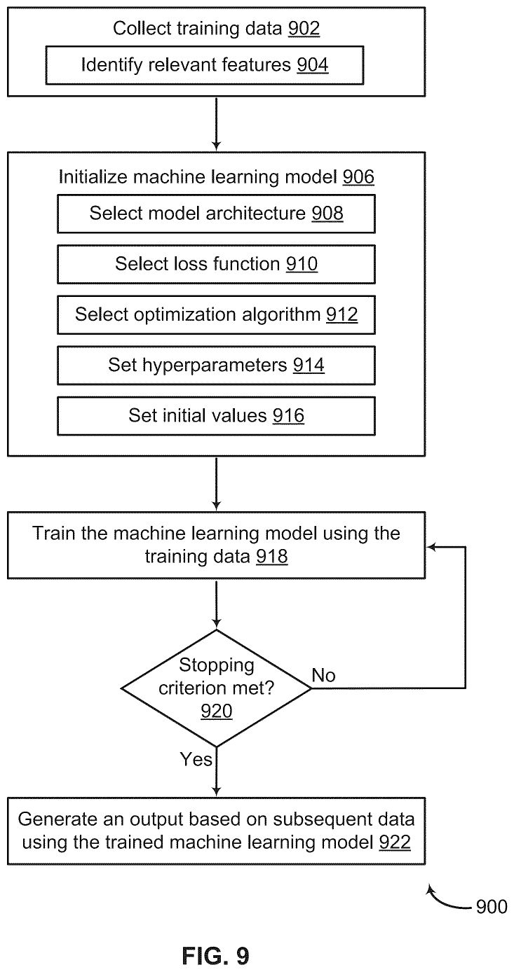

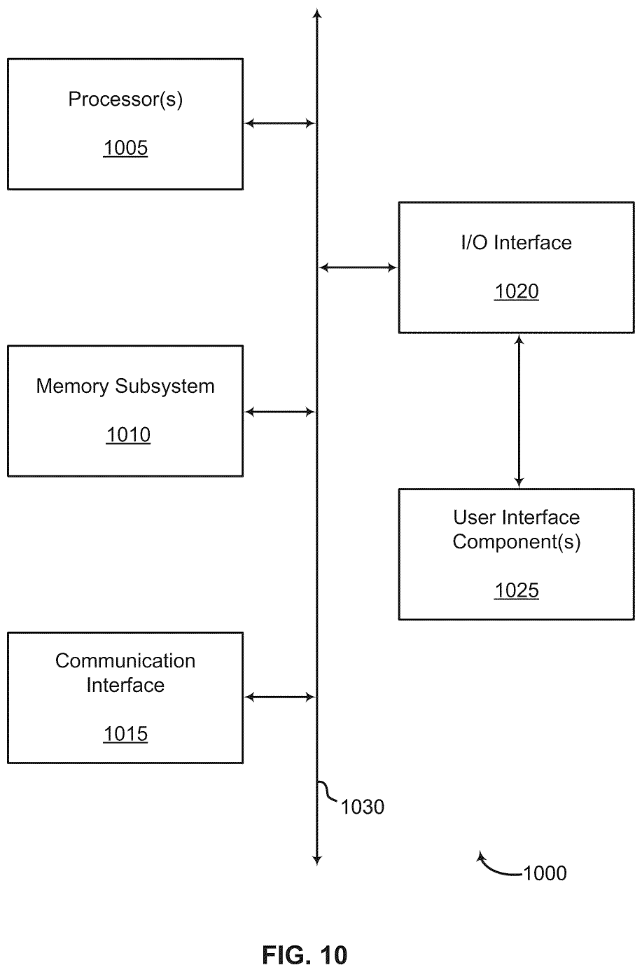

A linear attention system is described with reference to FIGS. 1-6. Methods for performing linear attention in O(n) time are described with reference to FIGS. 7-8. A training algorithm for a machine learning (ML) model is described with reference to FIG. 9. A computing device configured to implement a linear attention apparatus is described with reference to FIG. 10.

### Linear Attention System

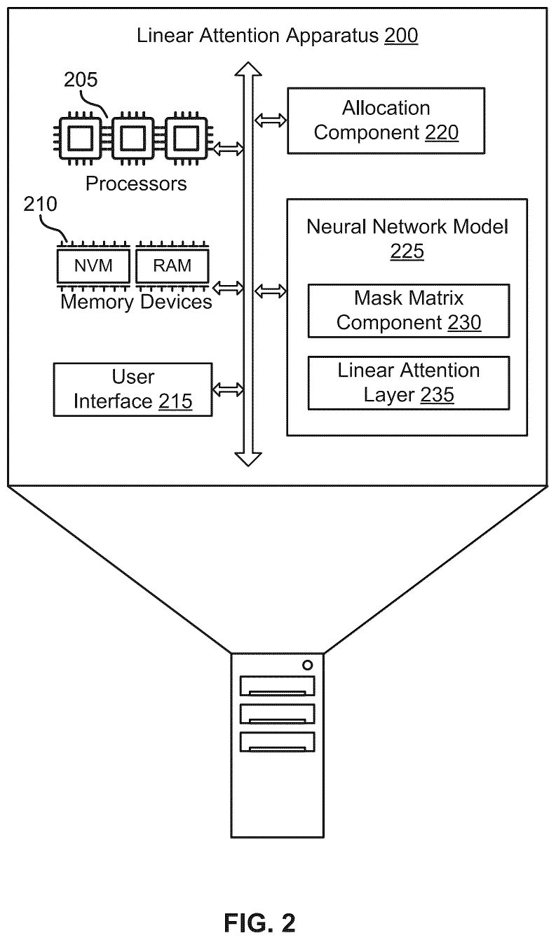

FIG. 1 shows an example of a linear attention system according to aspects of the present disclosure. The example shown includes linear attention apparatus 100, database 105, network 110, and user 115. Linear attention apparatus 100 is an example of, or includes aspects of, the corresponding element described with reference to FIG. 2.

In an example process, user 115 provides an input such as a text prompt. The text prompt may be a part of an interactive chat session, or directions for generating data such as image, audio, video, or additional text. The linear attention apparatus 100 receives the input, and may perform pre-processing operations such as tokenization to obtain an input vector. Then, linear attention apparatus 100 processes the input vector to obtain query, key, and value vectors, and partitions these vectors to obtain blocks. The blocks are loaded into a memory of, for example, a graphics processing unit (GPU) or other processor with multiple processing “cores”, and processed in parallel over a plurality of passes. As used herein, a “pass” refers to the loading in of new data into the memory. In some embodiments, a first pass includes computing key-value interactions between the blocks, a second pass includes performing a cumulative sum of the results from the first pass, and the third pass includes applying query operations to obtain output vector(s). The output vector(s) are then decoded to obtain the desired result; in this example, generated text responsive to the input from user 115.

Embodiments of linear attention apparatus 100 may be implemented in whole or in part on a server. A server provides one or more functions to users linked by way of one or more various networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 105 stores information used by the linear attention system, such as ML model parameters, training data, user configuration files, and the like. A database is an organized collection of data. For example, a database stores data in a specified format known as a schema. A database may be structured as a single database, a distributed database, multiple distributed databases, or an emergency backup database. In some cases, a database controller may manage data storage and processing in database 105. In some cases, user 115 interacts with the database controller. In other cases, the database controller may operate automatically without user interaction.

Network 110 facilitates the transfer of information between linear attention apparatus 100, database 105, and user 115. Network 110 is sometimes referred to as the “cloud.” A cloud is a computer network configured to provide on-demand availability of computer system resources, such as data storage and computing power. In some examples, the cloud provides resources without active management by user 115. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of a linear attention apparatus 200 according to aspects of the present disclosure. The example shown includes linear attention apparatus 200, processors 205, memory devices 210, user interface 215, allocation component 220, and neural network model 225.

Processors 205 perform computation, such as mathematical and logical operations. A processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor is configured to operate a memory array using a memory controller. In other cases, a memory controller is integrated into the processor. In some cases, the processor is configured to execute computer-readable instructions stored in a memory to perform various functions. In some embodiments, a processor includes special purpose components for modem processing, baseband processing, digital signal processing, or transmission processing.

In some embodiments, processors 205 include one or more graphics processing units (GPUs). A graphics processing unit is a specialized hardware component designed for parallel processing of large datasets, particularly useful in tasks requiring significant computational power, such as machine learning and scientific simulations. GPUs may function as discrete hardware components or be integrated alongside other processors, such as central processing units (CPUs), in a system. They are designed with numerous cores that can execute many instructions simultaneously, making them highly efficient for processing data in parallel.

In some cases, GPUs include tensor cores, which are specifically optimized for performing operations on tensors. Tensors are multi-dimensional arrays that are commonly used in machine learning and deep learning applications. The tensor cores enable efficient execution of tasks such as matrix multiplication and other linear algebra operations, which are essential for training and inference in neural networks. In some embodiments, GPUs also handle general-purpose computing tasks beyond graphical rendering, including specialized processing in systems-on-chip (SoC) architectures or high-performance computing environments.

Memory devices 210 store information used by processors 205 during operation of the linear attention apparatus 200. Examples of a memory device include random access memory (RAM), read-only memory (ROM), or a hard disk. Examples of memory devices 210 include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state. In some embodiments, processors 205 include the memory devices 210 in a single package, such as a GPU.

A user interface 215 enables a user to interact with a device. In some embodiments, user interface 215 may include an audio device, such as an external speaker system, an external display device such as a display screen, or an input device (e.g., remote control device interfaced with the user interface directly or through an IO controller module). In some cases, user interface 215 may be a graphical user interface (GUI). The user interface 215 may, for example, enable a user to provide inputs to linear attention apparatus 200 and view outputs generated by linear attention apparatus 200.

Allocation component 220 allocates data into memory devices 210. Prior to allocation, neural network model 225 may process an input using learned weight matrices to obtain query data, key data, and value data, which are represented in tensors. In some examples, the tensors have a sequence dimension n and a feature dimension d, where d is smaller than n. Allocation component 220 partitions these tensors along their sequence dimension into d×d-sized blocks. For example, if a tensor has dimensions nxd, allocation component 220 creates n/d blocks, each of size d×d. Then, allocation component 220 loads corresponding blocks of query data, key data, and value data into memory devices 210 for parallel processing. Each memory device 210 receives blocks representing the same portion of the input sequence. This allocation strategy enables parallel processing of key-value interactions across different sequence positions while maintaining the causal relationship between positions through subsequent cumulative operations. According to some aspects, allocation component 220 is configured to retrieve query data, key data, and value data from the at least one memory and to split the query data, the key data, and the value data to obtain the query data block, the key data block, and the value data block, respectively.

Neural network model 225 is configured to process query blocks, key blocks, and data blocks by performing an attention operation in O(n) time to generate output vectors. Embodiments of neural network model 225 include an artificial neural network (ANN) with trainable parameters. Particularly, neural network model 225 may include a modified Transformer model for processing the input data.

An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

A transformer or transformer network is a type of neural network models used for natural language processing tasks. A transformer network transforms one sequence into another sequence using an encoder and a decoder. The encoder and decoder include modules that can be stacked multiple times. These modules include attention and feed-forward layers. The inputs and outputs (target sequences) are first embedded into an n-dimensional space, and positional encoding is added to each embedded word to reflect its relative position in the sequence.

A transformer network includes an attention mechanism that examines an input sequence and determines which other parts of the sequence are important at each step. The attention mechanism uses queries (Q), keys (K), and values (V) to compute attention scores. In a typical transformer, Q is a matrix representing the query (the vector of a single word), while K and V represent all the keys and values (the vector representations of all words in the sequence). For encoder and decoder multi-head attention modules, Q and V often represent the same word sequence. However, in cross-attention between the encoder and decoder, V may represent a different sequence than Q.

In conventional systems, the attention operation requires quadratic time with respect to the length of the input sequence. This is because for every query, attention must compute dot products with all keys in the sequence, resulting in a time complexity of O(n²) for sequences of length n. This quadratic complexity can be computationally expensive, particularly for long sequences.

According to some aspects, neural network model 225 generates, using at least one of the set of processors 205, a first intermediate data block based on the key data block and the value data block. In some examples, neural network model 225 generates, using at least one of the processors 205, a second intermediate data block that accumulates values of the first intermediate data block and one or more previous first intermediate data blocks according to a data block ordering. In some examples, neural network model 225 generates, using at least one of processors 205, a linear attention data block based on the second intermediate data block, the query data block, the key data block, and the value data block.

In one aspect, neural network model 225 includes mask matrix component 230 and linear attention layer 235. Mask matrix component 230 generates and applies an n×n causal masking matrix M, where Mᵢⱼ=1 if i>j, and Mᵢⱼ=0 (or in some examples, −∞) if i<j. This structure ensures that predictions at position i can only attend to positions j where j≤i, enforcing causality in the attention operation. In some embodiments, the 1 values may alternatively be set to other values depending on the particular attention problem being solved. For example, in some embodiments, M may be structured as a one-semiseparable (1-SS) matrix, where the entries below the diagonal follow a cumulative product pattern. Such structured matrices can enable efficient implementations of the recurrence relationships inherent in sequential processing while maintaining the causal constraint. In some embodiments, where M includes positive values greater than 1, the neural network model 225 may apply these weights to query data blocks and key data blocks in a preprocessing step to obtain weighted query data blocks and weighted key data blocks, respectively.

According to some aspects, when M is structured as a one-semiseparable (1-SS) matrix, the linear attention operation becomes equivalent to a Recurrent Neural Network (RNN) with scalar input-dependent gates. In such embodiments, M can be expressed as a product of two rank-1 matrices. The entries of these rank-1 matrices can be represented as exponential functions of cumulative sums over sequence indices, where each sum operates on a function of the gates. According to further aspects, these rank-1 matrices can serve as weight matrices for the keys and queries, respectively. Experiments have been conducted on the application of these rank-1 matrices as weight matrices for keys and queries in embodiments of the present disclosure. These experiments show that when keys and queries are expressed in an exponential domain, the cumulative sums can be incorporated into the parametrization of keys and queries without introducing numerical instability. This incorporation is achieved through the combination of exponential functions, where the exponential of a sum equals the product of exponentials. This property enables embodiments to maintain numerical stability while preserving the causal structure of the attention mechanism.

There exist some approaches to O(n) linear attention that are based on a recurrent formulation of the relationship between Q, K, and V. However, these approaches are unable to parallelize attention operations. In contrast, the present embodiments reformulate the masking operation using mathematical identities that preserve the causal structure while enabling parallel computation. Specifically, mask matrix component 230 applies M to the attention operation in a way that allows linear attention layer 235 to process blocks of the sequence in parallel. This reformulation converts the element-wise masked product into a series of regular matrix operations. These matrix operations can then be efficiently computed using GPU tensor cores. Additional detail regarding this reformulation is described with reference to FIG. 7.

Linear attention layer 235 processes the allocated blocks to generate output vectors through multiple passes. In some embodiments, in a first pass, linear attention layer 235 computes key-value interactions for each block loaded into memory devices 210, with all blocks processed in parallel. These interactions capture relationships between features within each block of the sequence. In a second pass, linear attention layer 235 performs cumulative sum operations across the results from the first pass, effectively connecting information across blocks while maintaining causality. In a third pass, linear attention layer 235 applies query operations to the accumulated results to generate final output vectors. Each output vector represents a context-aware version of its corresponding input, incorporating information from all relevant prior positions in the sequence. This three-pass approach, which is enabled by the parallel block allocation strategy, achieves linear time complexity with respect to sequence length while preserving the causal structure of the attention mechanism. The three-pass approach is described in greater detail with reference to FIG. 7.

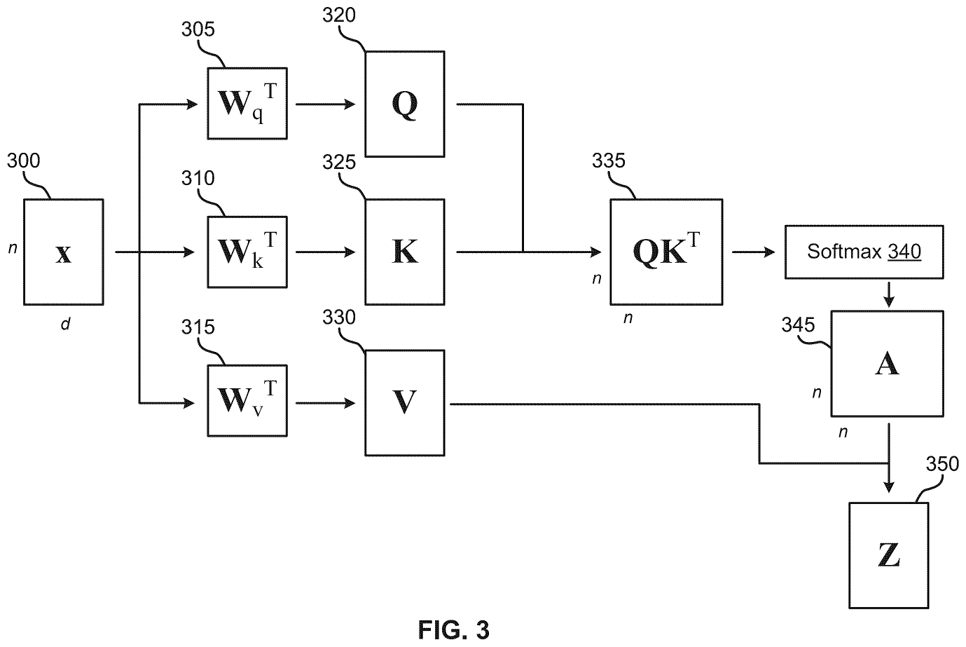

FIG. 3 shows an example of a conventional attention operation according to aspects of the present disclosure. The example shown includes input features 300, query weight matrix 305, key weight matrix 310, value weight matrix 315, query 320, key 325, value 330, attention matrix 335, softmax 340, attention weights 345, and output features 350.

In this example, input features 300 are represented as X, an n×d matrix where n is the length of the input sequence and d is the dimensionality of each feature. Input features 300 are multiplied by the respective weight matrices-query weight matrix 305, key weight matrix 310, and value weight matrix 315—to produce query 320 (Q), key 325 (K), and value 330 (V), respectively. Each of these weight matrices transforms the input features into representations that are used for the attention operation.

To transform the attention scores into attention weights, the system applies softmax 340 to the attention matrix 335. The softmax function ensures that the attention scores are normalized into a probability distribution, with values between 0 and 1. The resulting attention weights 345 are then applied to value 330 (V). For example, embodiments weight the value representations of each word or token according to the importance derived from the attention mechanism, where the importance of each embedding within value 330 (V) is represented by a corresponding value in attention weights 345.

The weighted sum of the values, produced by applying attention weights 345 to value 330, is then used to generate output features 350. The output features are a transformed representation of the input sequence, where each element in the sequence has been updated based on its attention to other elements in the sequence.

The attention process is the underlying technology behind many machine learning models, including large language models (LLMs). In such models, the encoder performs an initial attention operation on an input sequence, such as a text prompt, to generate contextualized features that capture relationships between the tokens in the sequence. The decoder, in turn, uses these encoded features and applies a continuous attention process. This involves attending to both the encoder's output and previously generated tokens from the decoder to predict the next token in the sequence. As the decoder generates each token, it re-applies attention to update the sequence based on the latest output, until the model predicts an <END> token.

In conventional systems, such as the process depicted in FIG. 3., the attention operation requires O(n²) time complexity. This is because the dot product between query 320 (Q) and key 325 (K) must be computed for each combination of n queries and n keys, resulting in an n×n attention matrix. As the input sequence length increases, the number of operations required grows quadratically, making this approach computationally expensive, particularly for long sequences.

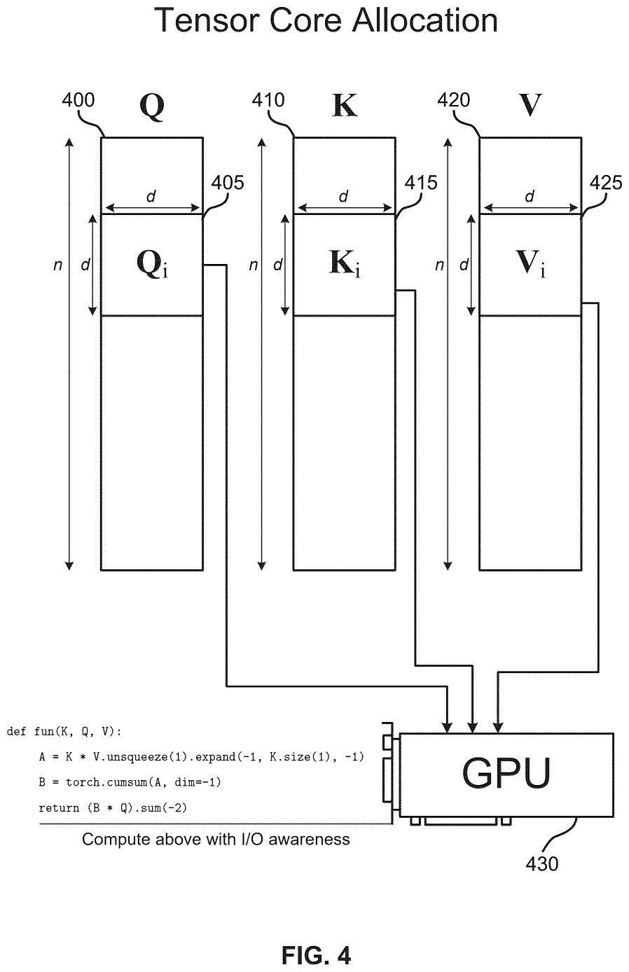

Query 320 is an example of, or includes aspects of, the corresponding element described with reference to FIG. 4. Key 325 is an example of, or includes aspects of, the corresponding element described with reference to FIG. 4. Value 330 is an example of, or includes aspects of, the corresponding element described with reference to FIG. 4.

FIG. 4 shows an example of block allocation according to aspects of the present disclosure. The example shown includes query 400, key 410, value 420, and GPU 430. Query 400, key 410, and value 420 are examples of, or include aspects of, the corresponding elements described with reference to FIG. 3. In one aspect, query 400 includes query data block 405, key 410 includes key data block 415, and value 420 includes value data block 425. The block allocation depicted in FIG. 4 may be performed be an allocation component as described with reference to FIG. 2.

As described with reference to FIG. 3, query 400, key 410, and value 420 are each n×d matrices, where n represents the sequence length and d represents the feature dimension. In some embodiments, allocation component 220 partitions these matrices along their sequence dimension into blocks of size d×d. For example, query data block 405, key data block 415, and value data block 425 represent corresponding d×d segments from their respective matrices.

GPU 430 receives these corresponding blocks for parallel processing. For example, when a set of blocks (query data block 405, key data block 415, and value data block 425) is loaded into GPU 430, these blocks represent the same portion of the input sequence. This alignment enables GPU 430 to efficiently compute key-value interactions for that sequence portion in parallel with other GPUs processing other portions.

Modern GPUs include specialized hardware units called tensor cores. These cores are optimized for matrix multiplication operations. Tensor cores can perform multiple matrix multiplications simultaneously. This makes them particularly efficient for processing d×d blocks of data. The block allocation strategy depicted in FIG. 4 is ‘I/O aware’. It ensures that corresponding blocks are processed together on the same GPU. Blocks may also be distributed across multiple GPUs when additional resources are available. This efficient use of tensor cores enables the parallel processing of blocks.

The parallel processing strategy operates at the block level. Embodiments may distribute the blocks across tensor cores or across individual GPUs for processing key-value interactions. After parallel processing, subsequent passes accumulate results across blocks. These passes connect information from different portions of the sequence while maintaining causality. In this way, embodiments achieve linear time complexity with respect to sequence length n, in contrast to the quadratic complexity of the conventional approach.

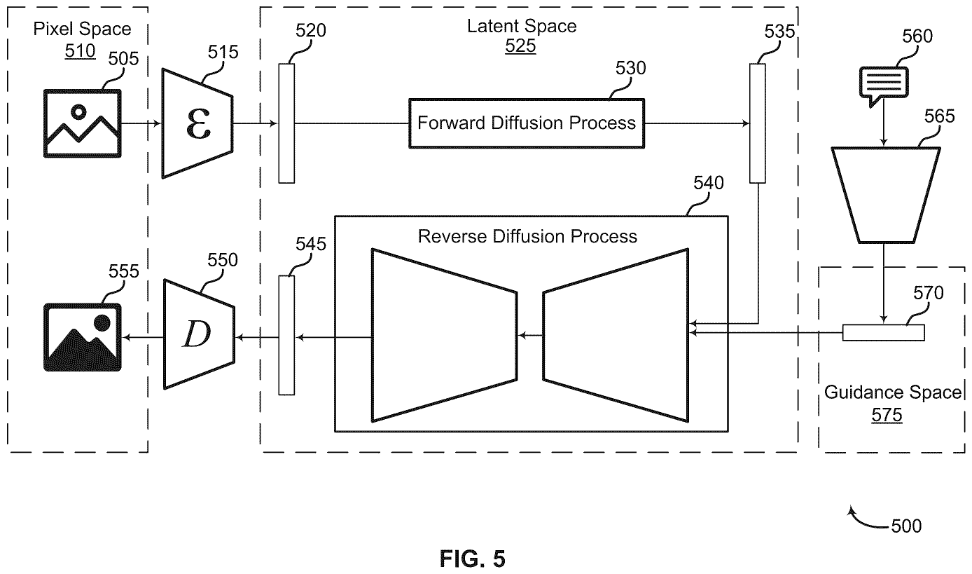

FIG. 5 shows an example of a guided latent diffusion model according to aspects of the present disclosure. Attention operations may be used when generating images with diffusion models. DDPMs incorporate attention mechanisms to enable the model to consider spatial relationships across the entire image during the denoising process. At each denoising step, the model computes attention scores between each pixel and all other pixels in the image, which allows the model to reference distant image regions when determining how to denoise a particular area.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 500 may take an original image 505 in a pixel space 510 as input and apply and image encoder 515 to convert original image 505 into original image features 520 in a latent space 525. Then, a forward diffusion process 530 gradually adds noise to the original image features 520 to obtain noisy features 535 (also in latent space 525) at various noise levels.

Next, a reverse diffusion process 540 (e.g., a U-Net ANN) gradually removes the noise from the noisy features 535 at the various noise levels to obtain denoised image features 545 in latent space 525. In some examples, the denoised image features 545 are compared to the original image features 520 at each of the various noise levels, and parameters of the reverse diffusion process 540 of the diffusion model are updated based on the comparison. Finally, an image decoder 550 decodes the denoised image features 545 to obtain an output image 555 in pixel space 510. In some cases, an output image 555 is created at each of the various noise levels. The output image 555 can be compared to the original image 505 to train the reverse diffusion process 540.

In some cases, image encoder 515 and image decoder 550 are pre-trained prior to training the reverse diffusion process 540. In some examples, they are trained jointly, or the image encoder 515 and image decoder 550 and fine-tuned jointly with the reverse diffusion process 540.

The reverse diffusion process 540 can also be guided based on a text prompt 560, or another guidance prompt, such as an image, a layout, a segmentation map, etc. The text prompt 560 can be encoded using a text encoder 565 (e.g., a multimodal encoder) to obtain guidance features 570 in guidance space 575. The guidance features 570 can be combined with the noisy features 535 at one or more layers of the reverse diffusion process 540 to ensure that the output image 555 includes content described by the text prompt 560. For example, guidance features 570 can be combined with the noisy features 535 using a cross-attention block within the reverse diffusion process 540.

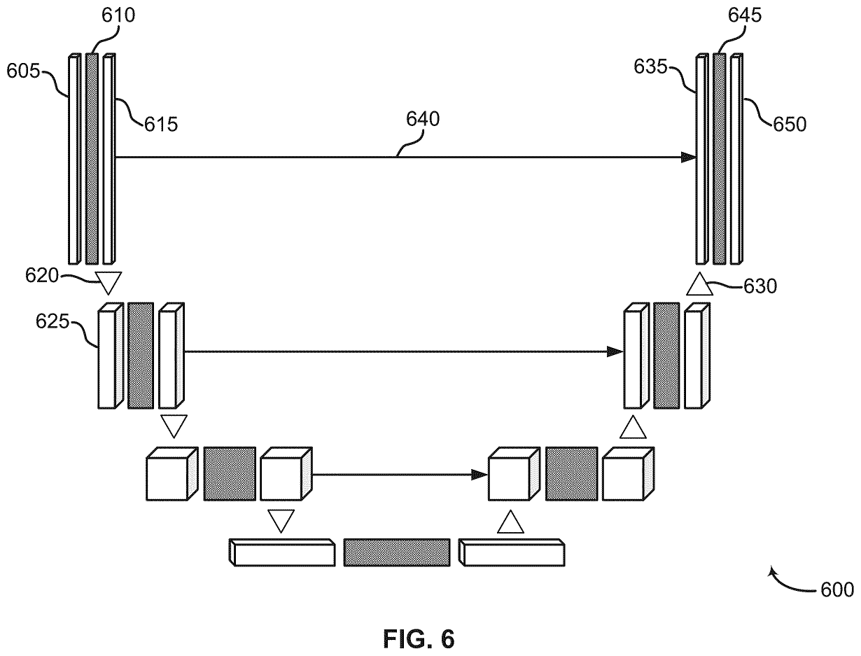

FIG. 6 shows an example of a U-Net 600 according to aspects of the present disclosure. In some examples, U-Net 600 is an example of the component that performs the reverse diffusion process 540 of guided diffusion model 500 described with reference to FIG. 5.

In some examples, diffusion models are based on a neural network architecture known as a U-Net. The U-Net 600 takes input features 605 having an initial resolution and an initial number of channels and processes the input features 605 using an initial neural network layer 610 (e.g., a convolutional network layer) to produce intermediate features 615. The intermediate features 615 are then down-sampled using a down-sampling layer 620 such that down-sampled features 625 have a resolution less than the initial resolution and a number of channels greater than the initial number of channels.

This process is repeated multiple times, and then the process is reversed. That is, the down-sampled features 625 are up-sampled using up-sampling process 630 to obtain up-sampled features 635. The up-sampled features 635 can be combined with intermediate features 615 having a same resolution and number of channels via a skip connection 640. These inputs are processed using a final neural network layer 645 to produce output features 650. In some cases, the output features 650 have the same resolution as the initial resolution and the same number of channels as the initial number of channels.

In some cases, U-Net 600 takes additional input features to produce conditionally generated output. For example, the additional input features could include a vector representation of an input prompt. The additional input features can be combined with the intermediate features 615 within the neural network at one or more layers. For example, a cross-attention module can be used to combine the additional input features and the intermediate features 615. The cross-attention module may be configured to implement the parallel causal attention described herein.

### Parallel Causal Attention

FIG. 7 shows an example of a method 700 for performing parallel causal linear attention in three passes according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to some aspects, the standard, softmax-based causal attention maps an input X (as query data Q, key data K, and value data V) to an output sequence Y via the following relationship:

$$Y = softmax ( ( {QK}^{T} ) ⊙ M ) * V \qquad ( 1 )$$

where ‘softmax’ is a function that normalizes its input vector into a probability distribution by exponentiating each element and dividing by the sum of all exponentiated values, superscript T denotes the matrix transpose operation that converts an n×d matrix into a d×n matrix, and M is a mask as described with reference to FIG. 2. The operator ⊙ denotes element-wise multiplication (Hadamard product) between matrices of the same size.

Linear attention (e.g., without the non-linear softmax function) can be formulated like so:

$$Y = ( ( {QK}^{T} ) ⊙ M ) * V \qquad ( 2 )$$

Conventional approaches assume that due to M it is not possible to exploit the associative property of matrix multiplication to reduce the parallel form complexity from quadratic to linear. However, embodiments achieve parallel form by utilizing an identity of Hadamard products:

$$( A ⊙ M ) * x = {diag}^{- 1} ( M * diag ( x ) {A}^{T} ) \qquad ( 3 )$$

where diag and diag⁻¹ are operators that convert a vector into a diagonal matrix and back, respectively. Applying this identity twice to the right hand side of Equation (2) yields:

$$\begin{matrix}( ( {QK}^{T} ) M ) * v = {diag}^{- 1} ( M * diag ( x ) {KQ}^{T} ) \\ = ( Q ⊙ ( M diag ( v ) K ) ) * {1}_{d}\end{matrix} \qquad ( 4 )$$

where 1_{d} is a d-vector of ones. By efficiently allocating blocks of Q, K, and V, embodiments implement Equation (4) in O(n) time. This process will now be described in detail in an example three-pass operation.

At operation 705, the system partitions sequence into chunks and process key-value interactions in parallel. For example, embodiments may compute key-value interactions via the following relationship:

$$\begin{matrix}First Pass & for all i , in parallel \text{:} {KV}_{i} = {K}_{i}^{T} * {V}_{i}\end{matrix} \qquad ( 5 )$$

where Kᵢ is the key block for position i within key K, Vᵢ is the value block for position i, and KVᵢ is an initial key-value interaction matrix for position i. These are matrix multiplication operations that can be effectively computed in parallel across tensor cores and/or multiple GPUs. Each block represents a d×d portion of the sequence. The parallel computation of these interactions avoids computing a full attention matrix.

At operation 710, the system computes cumulative sums across chunks to connect interactions. For example:

$$\begin{matrix}Second Pass & {CKV}_{i} = {\sum }_{k = 1}^{i} {KV}_{k}\end{matrix} \qquad ( 6 )$$

where CKVᵢ is a cumulative sum of key-value interaction matrices up to position i. This computation connects information across blocks while maintaining causality. The cumulative sum ensures that each position has access to information from all previous positions.

At operation 715, the system apply queries matrices to accumulated results to generate final outputs. For example:

$$\begin{matrix}Third Pass & for all i , in parallel :\end{matrix} \qquad ( 3 )$$

$${O}_{i} = {Q}_{i}^{T} * {CKV}_{i} + ( ( {Q}_{i} * {K}_{i}^{T} ) ⊙ {M}_{i , i} ) * {V}_{i}$$

where Qᵢ query matrix for position i, M_{i,i} is causal mask matrix for position i as described with reference to FIG. 2, and Oᵢ is an attention output for position i. According to some aspects, this pass applies query operations to the accumulated key-value interactions from previous passes with

$${Q}_{i}^{T} * {CKV}_{i} ,$$

and further computes query-key interactions that sum over feature dimensions rather than time indices with

$$( ( {Q}_{i} * {K}_{i}^{T} ) ⊙ {M}_{i , i} ) * {V}_{i} .$$

The combination of these computations produces context-aware output vectors Oᵢ that incorporate both temporal and feature-space relationships.

FIG. 8 shows an example of a method 800 for performing a linear attention operation in parallel according to aspects of the present disclosure. In some examples, these operations are performed by a system including a processor executing a set of codes to control functional elements of an apparatus. Additionally or alternatively, certain processes are performed using special-purpose hardware. Generally, these operations are performed by a set of processors that implement a neural network model as described with reference to FIG. 2, according to the methods and processes described in accordance with aspects of the present disclosure. In some cases, the operations described herein are composed of various substeps, or are performed in conjunction with other operations. Additional detail regarding the following operations is described with reference to FIGS. 4 and 7.

At operation 805, the system obtains a query data block, a key data block, and a value data block of a neural network model. These blocks represent d×d portions of their respective query, key, and value matrices, partitioned along the sequence dimension n. The blocks may correspond to the same portion of the input sequence for parallel computation.

At operation 810, the system generates, using at least one of the set of processors, a first intermediate data block based on the key data block and the value data block. According to some aspects, this operation computes key-value interactions for the corresponding sequence portion through matrix multiplication operations. These computations occur in parallel with other processors computing interactions for other sequence portions.

At operation 815, the system generates, using at least one of the set of processors, a second intermediate data block that accumulates values of the first intermediate data block and one or more previous first intermediate data blocks according to a data block ordering. According to some aspects, this accumulation connects information across blocks while maintaining causality through cumulative operations over the sequence of blocks.

At operation 820, the system generates, using at least one of the set of processors, a linear attention data block based on the second intermediate data block, the query data block, the key data block, and the value data block. This operation combines the accumulated key-value interactions with query operations to produce context-aware representations for the sequence portion.

At operation 825, the system performs a linear attention mechanism of the neural network model based on the linear attention data block. The resulting output incorporates information from relevant prior positions while maintaining the causal structure of the attention operation. The linear attention mechanism and the reformulation of its computation are described in detail with reference to FIGS. 3 and 7, respectively.

FIG. 9 is a flow diagram depicting an algorithm as a step-by-step procedure 900 in an example implementation of operations performable for training a machine-learning model. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which, the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (block 912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model.

FIG. 10 shows an example of a computing device 1000 according to aspects of the present disclosure. The example shown includes computing device 1000, processor(s) 1005, memory subsystem 1010, communication interface 1015, I/O interface 1020, user interface component(s), and channel 1030.

In some embodiments, computing device 1000 is an example of, or includes aspects of, a linear attention apparatus as described in FIGS. 1 and 2. In some embodiments, computing device 1000 includes one or more processors 1005 are configured to execute instructions stored in memory subsystem 1010 to obtain a query data block, a key data block, and a value data block of a neural network model; generate, using at least one of the plurality of processors, a first intermediate data block based on the key data block and the value data block; generate, using at least one of the plurality of processors, a second intermediate data block that accumulates values of the first intermediate data block and one or more previous first intermediate data blocks according to a data block ordering; generate, using at least one of the plurality of processors, a linear attention data block based on the second intermediate data block, the query data block, the key data block, and the value data block; and perform a linear attention mechanism of the neural network model based on the linear attention data block.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote-control device interfaced with a user interface directly or through the I/O controller), or a combination thereof. In some cases, user interface component(s) 1025 include a GUI.

Accordingly, the present disclosure includes the following aspects.

A method of performing an attention operation using a plurality of processors is described. The method includes obtaining a query data block, a key data block, and a value data block of a neural network model; generating, using at least one of the plurality of processors, a first intermediate data block based on the key data block and the value data block; generating, using at least one of the plurality of processors, a second intermediate data block that accumulates values of the first intermediate data block and one or more previous first intermediate data blocks according to a data block ordering; generating, using at least one of the plurality of processors, a linear attention data block based on the second intermediate data block, the query data block, the key data block, and the value data block; and performing a linear attention mechanism of the neural network model based on the linear attention data block.

Some examples of the method, apparatus, non-transitory computer readable medium, and system further include retrieving query data, key data, and value data of the neural network model from the at least one memory. Some examples further include splitting the query data, the key data, and the value data to obtain the query data block, the key data block, and the value data block, respectively.

Some examples of the method, apparatus, non-transitory computer readable medium, and system further include generating a plurality of first intermediate data blocks using the plurality of processors, respectively, wherein the second intermediate data block accumulates values from the plurality of first intermediate data blocks. In some aspects, the query data block comprises a weighted query data block and the key data block comprises a weighted key data block.

Some examples of the method, apparatus, non-transitory computer readable medium, and system further include generating a third intermediate data block based on the query data block and the key data block. Some examples further include generating a fourth intermediate data block based on the third intermediate data block and a diagonal mask. Some examples further include computing a fifth intermediate data block based on the fourth intermediate data block and the value data block. Some examples further include computing a sixth intermediate data block based on the query data block and the second intermediate data block, wherein the linear attention data block is based on the fifth and the sixth intermediate data block. Some examples include generating a plurality of linear attention data blocks, wherein the linear attention mechanism is based on the plurality of linear attention data blocks.

Some examples of the method, apparatus, non-transitory computer readable medium, and system further include performing a plurality of passes, wherein each of the plurality of passes includes retrieving data from the at least one memory, processing the data using the plurality of processors to obtain linear attention data, and storing the linear attention data in the at least one memory.

A method of performing an attention operation using a plurality of processors is described. The method includes obtaining a query data block, a key data block, and a value data block of a neural network model; generating a first intermediate data block based on the key data block and the value data block; generating a second intermediate data block that accumulates values of the first intermediate data block and one or more previous first intermediate data blocks; generating a linear attention data block based on the second intermediate data block, the query data block, the key data block, and the value data block; and performing a linear attention mechanism of the neural network model based on the linear attention data block.

Some examples of the method, apparatus, non-transitory computer readable medium, and system further include generating a plurality of first intermediate data blocks using the plurality of processors, respectively, wherein the second intermediate data block accumulates values from the plurality of first intermediate data blocks. In some aspects, the one or more previous first intermediate data blocks have a lower index value than the first intermediate data block.

Some examples of the method, apparatus, non-transitory computer readable medium, and system further include generating a third intermediate data block based on the query data block and the key data block. Some examples further include generating a fourth intermediate data block based on the third intermediate data block and a diagonal mask. Some examples further include computing a fifth intermediate data block based on the fourth intermediate data block and the value data block. Some examples further include computing a sixth intermediate data block based on the query data block and the second intermediate data block, wherein the linear attention data block is based on the fifth and the sixth intermediate data block.

Some examples of the method, apparatus, non-transitory computer readable medium, and system further include generating a plurality of linear attention data blocks, wherein the linear attention mechanism is based on the plurality of linear attention data blocks. Some examples further include performing a plurality of passes, wherein each of the plurality of passes includes retrieving data from at least one memory, processing the data using the plurality of processors to obtain linear attention data, and storing the linear attention data in the at least one memory.

An apparatus for performing attention operations is described. One or more aspects of the apparatus include a plurality of processors; at least one memory storing code executable by the plurality of processors; and a neural network model configured to generate a first intermediate data block based on a key data block and a value data block, generate a second intermediate data block that accumulates values of the first intermediate data block and one or more previous first intermediate data blocks, generate a linear attention data block based on the second intermediate data block, a query data block, the key data block, and the value data block, and perform a linear attention mechanism based on the linear attention data block.

Some examples of the apparatus, system, and method further include an allocation component configured to retrieve query data, key data, and value data from the at least one memory and to split the query data, the key data, and the value data to obtain the query data block, the key data block, and the value data block, respectively. In some aspects, the neural network model is further configured to generate a plurality of first intermediate data blocks using the plurality of processors, respectively, wherein the second intermediate data block accumulates values from the plurality of first intermediate data blocks.

In some aspects, the neural network model is further configured to generate a third intermediate data block based on the query data block and the key data block, generate a fourth intermediate data block based on the third intermediate data block and a diagonal mask, compute a fifth intermediate data block based on the fourth intermediate data block and the value data block, and compute a sixth intermediate data block based on the query data block and the second intermediate data block, wherein the linear attention data block is based on the fifth and the sixth intermediate data block.

In some aspects, the neural network model is further configured to generate a plurality of linear attention data blocks, wherein the linear attention mechanism is based on the plurality of linear attention data blocks. In some aspects, the neural network model is further configured to perform a plurality of passes, wherein each of the plurality of passes includes retrieving data from the at least one memory, processing the data using the plurality of processors to obtain linear attention data, and storing the linear attention data in the at least one memory. In some aspects, the neural network model is configured to perform single-head linear attention. The neural network model may be optimized to perform single-head linear attention with a batch size of 1.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a query data block, a key data block, and a value data block of a neural network model;
generating a first intermediate data block based on the key data block and the value data block;
generating a second intermediate data block that accumulates values corresponding to the first intermediate data block and one or more previous first intermediate data blocks based on a data block ordering;
generating a linear attention data block based on the second intermediate data block, the query data block, the key data block, and the value data block; and
performing a linear attention mechanism of the neural network model based on the linear attention data block.

2. The method of claim 1, further comprising:
retrieving query data, key data, and value data of the neural network model from the at least one memory; and
splitting the query data, the key data, and the value data to obtain the query data block, the key data block, and the value data block, respectively.

3. The method of claim 1, further comprising:
generating a plurality of first intermediate data blocks using a plurality of processors, respectively, wherein the second intermediate data block accumulates values from the plurality of first intermediate data blocks.

4. The method of claim 2, wherein:
the first intermediate data block and the one or more previous first intermediate data blocks are generated by the plurality of different processors, respectively.

5. The method of claim 1, wherein generating the linear attention data block comprises:
generating a third intermediate data block based on the query data block and the key data block;
generating a fourth intermediate data block based on the third intermediate data block and a diagonal mask;
computing a fifth intermediate data block based on the fourth intermediate data block and the value data block; and
computing a sixth intermediate data block based on the query data block and the second intermediate data block, wherein the linear attention data block is based on the fifth and the sixth intermediate data block.

6. The method of claim 1, wherein performing the linear attention mechanism comprises:
generating a plurality of linear attention data blocks, wherein the linear attention mechanism is based on the plurality of linear attention data blocks.

7. The method of claim 1, wherein performing the linear attention mechanism comprises:
performing a plurality of passes, wherein each of the plurality of passes includes retrieving data from the at least one memory, processing the data using a plurality of processors to obtain linear attention data, and storing the linear attention data in the at least one memory.

8. A non-transitory computer readable medium storing code, the code comprising instructions the code comprising instructions executable by a plurality of processors to:
obtain a query data block, a key data block, and a value data block of a neural network model;
generate, using a first processor, a first intermediate data block based on the key data block and the value data block;
generate a second intermediate data block based on the first intermediate data block and a previous first intermediate data block generated by a second processor;
generate a linear attention data block based on the second intermediate data block, the query data block, the key data block, and the value data block; and
perform a linear attention mechanism of the neural network model based on the linear attention data block.

9. The non-transitory computer readable medium of claim 8, the code further comprising instructions executable by the plurality of processors to:
generate a plurality of first intermediate data blocks using a plurality of processors, respectively, wherein the second intermediate data block accumulates values from the plurality of first intermediate data blocks.

10. The non-transitory computer readable medium of claim 8, wherein:
the one or more previous first intermediate data blocks have a lower index value than the first intermediate data block.

11. The non-transitory computer readable medium of claim 8, the code further comprising instructions executable by the plurality of processors to:
generate a third intermediate data block based on the query data block and the key generate a fourth intermediate data block based on the third intermediate data block and a diagonal mask;
compute a fifth intermediate data block based on the fourth intermediate data block and the value data block; and
compute a sixth intermediate data block based on the query data block and the second intermediate data block, wherein the linear attention data block is based on the fifth and the sixth intermediate data block.

12. The non-transitory computer readable medium of claim 8, the code further comprising instructions executable by the plurality of processors to:
generate a plurality of linear attention data blocks, wherein the linear attention mechanism is based on the plurality of linear attention data blocks.

13. The non-transitory computer readable medium of claim 8, the code further comprising instructions executable by the plurality of processors to:
perform a plurality of passes, wherein each of the plurality of passes includes retrieving data from at least one memory, processing the data using a plurality of processors to obtain linear attention data, and storing the linear attention data in the at least one memory.

14. A system comprising:
a plurality of processors; and
at least one memory storing code executable by the plurality of processors, the code comprising instructions executable to perform operations comprising:
obtaining a query data block, a key data block, and a value data block of a neural network model;
generating a first intermediate data block based on the key data block and the value generating a second intermediate data block that accumulates values corresponding to the first intermediate data block and one or more previous first intermediate data blocks based on a data block ordering;
generating a linear attention data block based on the second intermediate data block, the query data block, the key data block, and the value data block; and
performing a linear attention mechanism of the neural network model based on the linear attention data block.

15. The system of claim 14, further comprising:
an allocation component configured to retrieve query data, key data, and value data from the at least one memory and to split the query data, the key data, and the value data to obtain the query data block, the key data block, and the value data block, respectively.

16. The system of claim 14, wherein:
the neural network model is further configured to generate a plurality of first intermediate data blocks using the plurality of processors, respectively, wherein the second intermediate data block accumulates values from the plurality of first intermediate data blocks.

17. The system of claim 14, wherein:
the neural network model is further configured to generate a third intermediate data block based on the query data block and the key data block, generate a fourth intermediate data block based on the third intermediate data block and a diagonal mask, compute a fifth intermediate data block based on the fourth intermediate data block and the value data block, and compute a sixth intermediate data block based on the query data block and the second intermediate data block, wherein the linear attention data block is based on the fifth and the sixth intermediate data block.

18. The apparatus of claim 14, wherein:
the neural network model is further configured to generate a plurality of linear attention data blocks, wherein the linear attention mechanism is based on the plurality of linear attention data blocks.

19. The apparatus of claim 14, wherein:
the neural network model is further configured to perform a plurality of passes, wherein each of the plurality of passes includes retrieving data from the at least one memory, processing the data using the plurality of processors to obtain linear attention data, and storing the linear attention data in the at least one memory.

20. The apparatus of claim 14, wherein:
the neural network model is configured to perform single-head linear attention.
